(19) United States
(12) Patent Application Publication
(10) Pub. No.: US 2023/0237370 A1
(43) Pub. Date: Jul. 27, 2023

(54) METHODS FOR TRAINING AN ARTIFICIAL INTELLIGENT AGENT WITH CURRICULUM AND SKILLS

(71) Applicants: Sony Group Corporation, Tokyo (JP); Sony Corporation of America, New York, NY (US)

(72) Inventors: Thomas J. Walsh, Melrose, MA (US); Varun Kompella, Kanata (CA); Samuel Barrett, Cambridge, MA (US); Michael D. Thomure, Portland, OR (US); Patrick MacAlpine, Seattle, WA (US); Peter Wurman, Acton, MA (US)

(21) Appl. No.: 17/650,295

(22) Filed: Feb. 8, 2022

Related U.S. Application Data
(60) Provisional application No. 63/267,136, filed on Jan. 25, 2022.

(51) Int. Cl. G06N 20/00

(52) U.S. Cl. CPC G06N 20/00

(57) ABSTRACT

A method for training an agent uses a mixture of scenarios designed to teach specific skills helpful in a larger domain, such as mixing general racing and very specific tactical racing scenarios. Aspects of the methods can include one or more of the following: (1) training the agent to be very good at time trials by having one or more cars spread out on the track; (2) running the agent in various racing scenarios with a variable number of opponents starting in different configurations around the track; (3) varying the opponents by using game-provided agents, agents trained according to aspects of the present invention, or agents controlled to follow specific driving lines; (4) setting up specific short scenarios with opponents in various racing situations with specific success criteria; and (5) having a dynamic curriculum based on how the agent performs on a variety of evaluation scenarios.

### BACKGROUND OF THE INVENTION

### 1. Field of the Invention

Embodiments of the invention relates generally training artificial intelligent agents. More particularly, the invention relates to methods for training a gaming agent with both general game play and placing the agent in specific scenarios. Even more particularly, aspects of the present invention can use mixed scenario training for reinforcement learning in configurable environments, such as racing game agents.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Referring to FIG. 1, reinforcement learning (RL) agents 100 are a form of artificial intelligence that are trained (also called “learning”) through interactions with their environment 102. On every time step of an agent's training, it is provided with observations 104 of its current state. The agent 100 then takes an action 106 which transitions it to a new state and produces a reward term. Various existing RL algorithms and models 108 provide routines for eventually finding an optimal policy 110, a mapping from states to actions, that will maximize some function (such as the expected sum) of the reward terms.

In simple domains, RL agents are expected to be able to experience all possible states based on their own actions. However, in complex problems, such as learning to drive or even race an autonomous vehicle in traffic, a learning agent that needs data from an informative learning scenario such as driving between two cars, will encounter many challenges. For example, if the environment is large enough, random or even targeted exploration by a learning agent will have too many areas to explore, likely missing out on important scenarios.

Further, reinforcement learning agents almost always have a finite horizon (or effective finite horizon) in their planning, so even if they identify a scenario that they want to visit, it may not be feasible for them to execute a plan to reach it. If the agent needs data between two cars but the cars are far away, it may not have a reliable way of reaching them.

Also, when other agents share the environment, they may not take actions that lead to the experience the learning agent needs. For instance, if the autonomous driving system is a racing simulator, two cars will not slow down to let the learning agent in between them. Even if the learning agent manages to experience a scenario like driving between two cars, the amount of experience needed to reach that scenario will likely be far larger than the experience in the scenario, minimizing its effect on training.

Furthermore, complex environments often come with strong prior knowledge from human experience about what scenarios will be helpful in learning. For instance, a driving instructor could likely stipulate many scenarios that will help an agent learn. But no encoding of these known learning scenarios is available in the basic reinforcement learning formulation.

To learn effectively in such complex domains without the ability to simply run the agent for an overwhelming number of steps, these problems need to be remedied.

An example of such a complex environment where an agent needs multiple skills to be successful is simulated automobile racing. To be skilled at controlling the race car, drivers develop a detailed understanding of the dynamics of their vehicle and the idiosyncrasies of the track on which they are racing. Drivers build upon this foundation with tactical skills needed to pass and defend against opponents, executing precise maneuvers at high speed with little margin for error.

### SUMMARY OF THE INVENTION

Embodiments of the present invention provide a method of training a reinforcement learning agent with mixed scenario training comprising providing a rollout worker in an environment having one or more predetermined scenario properties; operating the rollout worker in the environment while focusing on one or more specific skills; providing a reward for successfully achieving the one or more specific skills; and creating a policy for the rollout worker to optimize the reward.

Embodiments of the present invention further provide a deep reinforcement learning architecture using mixed scenario training comprising a set of rollout workers; a trainer; and a set of scenario properties, wherein the trainer refines models and policies used to determine actions of a rollout worker in an environment; the rollout workers operate in the environment based on predetermined launch conditions retrieved from the scenario properties; and data from the rollout workers operating in the environment with the predetermined launch conditions is collected and stored in an experience replay buffer of the trainer.

Embodiments of the present invention also provide a method of training an agent with deep reinforcement learning to interact in a racing video game, comprising learning a policy that selects an action based on observations by the agent and based on a value function that estimates a future rewards for each possible action; mapping core actions of the agent to either a changing velocity dimension and a steering dimension, wherein the changing velocity dimension and the steering dimension are both continuous-valued dimensions; and training the agent in an environment with predefined scenario properties, wherein the predefined scenario properties includes launch conditions, opponent distribution options, a replication number, stopping conditions, experience table mapping and scenario weighting.

In some embodiments, the method further includes providing the agent with position, velocity, and acceleration state information about itself and each opponent and providing the agent with a map of a track as a list of points defining left and right edges and a centerline thereof.

In some embodiments, the method further includes training the agent in racing scenarios with a variable number of opponents and with starting at different configurations around a track and training the agent against opponents selected from game-provided artificial agents, other agents trained with varying reward functions, and agents controlled by controllers that are following specific driving lines.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a schematic representation of a reinforcement learning agent interacting with its environment;

FIG. 2 illustrates scenario components and their consumers for a single environment for mixed scenario training, according to an exemplary embodiment of the present invention;

FIG. 3 illustrates a full mixed scenario training schematic according to an exemplary embodiment of the present invention;

FIG. 4 illustrates an exemplary system configuration where a trainer distributes training scenarios to rollout workers, each of which controls one game console running an instance of a racing game;

FIGS. 5a through 5f illustrate scenario configurations on three different racing tracks used to train agents using mixed scenario training;

FIGS. 6a and 6b illustrate an ablation study of various aspects of the scenarios used to train a racing agent. As scenarios are modified or dropped, the agent's ability to acquire and maintain crucial skills degrades;

FIG. 7 illustrates the contents of an experience replay buffer that uses multiple tables to organize data from different scenarios; and

FIGS. 8a through 8c present race results of a mixed-scenario trained agent against four of the best drivers in a simulated racing game.

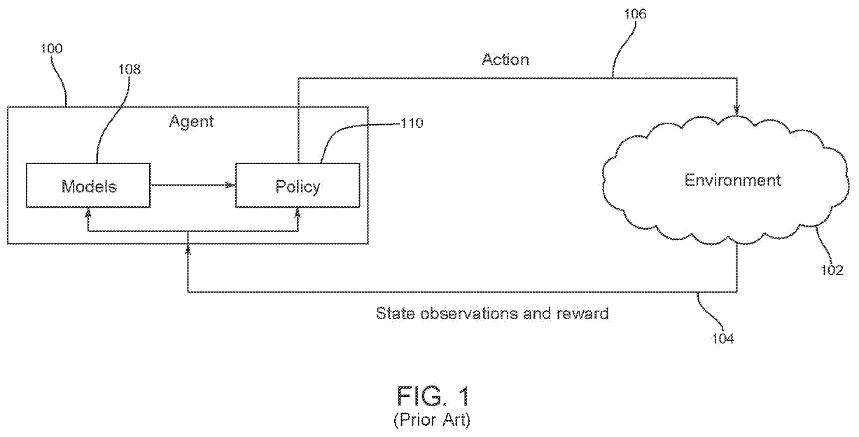

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary, a variety of optional components are described to illustrate the wide variety of possible embodiments of the present invention.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include code segments in one or more computer-readable languages; graphical and or/textual instructions; applets; pre-compiled code; interpreted code; compiled code; and computer programs.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G, 5G and the like.

Embodiments of the present invention may include apparatuses for performing the operations disclosed herein. An apparatus may be specially constructed for the desired purposes, or it may comprise a general-purpose device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

The term “agent” or “intelligent agent” or “artificial agent” or “artificial intelligent agent” is meant to refer to any man-made entity that chooses actions in response to observations. “Agent” may refer without limitation to a robot, to a simulated robot, to a software agent or “bot”, an adaptive agent, an internet or web bot.

The term “robot” may refer to any system controlled directly or indirectly by a computer or computing system that issues actions or commands in response to senses or observations. The term may refer without limitation to a traditional physical robot with physical sensors such as cameras, touch sensors, range sensors, and the like, or to a simulated robot that exists in a virtual simulation, or to a “bot” such as a gaming bot that exists as software in a network.

The terms “observation” or “observations” refers to any information the agent receives by any means about the agent's environment or itself. In some embodiments, that information may be sensory information or signals received through sensory devices, such as without limitation cameras, touch sensors, range sensors, temperature sensors, wavelength sensors, sound or speech sensors, position sensors, pressure or force sensors, velocity or acceleration or other motion sensors, location sensors (e.g., GPS), etc. In other embodiments that information could also include without limitation compiled, abstract, or situational information compiled from a collection of sensory devices combined with stored information. In a non-limiting example, the agent may receive as observation abstract information regarding the location or characteristics of itself or other objects.

The term “action” refers to the agent's any means for controlling, affecting, or influencing the agent's environment, the agent's physical or simulated self or the agent's internal functioning which may eventually control or influence the agent's future actions, action selections, or action preferences. In many embodiments the actions may directly control a physical or simulated servo or actuator. In some embodiments the actions may be the expression of a preference or set of preferences meant ultimately to influence the agent's choices. In some embodiments, information about agent's action(s) may include, without limitation, a probability distribution over agent's action(s), and/or outgoing information meant to influence the agent's ultimate choice of action.

The term “state” or “state information” refers to any collection of information regarding the state of the environment or agent, which may include, without limitation, information about the agent's current and/or past observations.

The term “policy” refers to any function or mapping from any full or partial state information to any action information. Policies may be hard coded or may be modified, adapted or trained with any appropriate learning or teaching method, including, without limitation, any reinforcement-learning method or control optimization method. A policy may be an explicit mapping or may be an implicit mapping, such as without limitation one that may result from optimizing a particular measure, value, or function. A policy may include associated additional information, features, or characteristics, such as, without limitation, starting conditions (or probabilities) that reflect under what conditions the policy may begin or continue, termination conditions (or probabilities) reflecting under what conditions the policy may terminate.

Broadly, embodiments of the present invention provide methods for training an agent with a mixture of general racing and very specific racing scenarios. Aspects of the methods can include one or more of the following: (1) training the agent to be very good at time trials by having one or more cars spread out on the track; (2) running the agent in various racing scenarios with a variable number of opponents starting in different configurations around the track; (3) varying the opponents by using game-provided agents, earlier versions of agents trained according to aspects of the present invention, agents trained by for different behaviors, or agents controlled by controllers that are following specific driving lines; (4) setting up specific short scenarios with opponents in various racing situations with specific success criteria; and (5) having a dynamic curriculum based on how the agent performs on a variety of evaluation scenarios. The training methods can use, for example, a quantile-regression soft actor-critic model-free off-policy deep reinforcement learning technique.

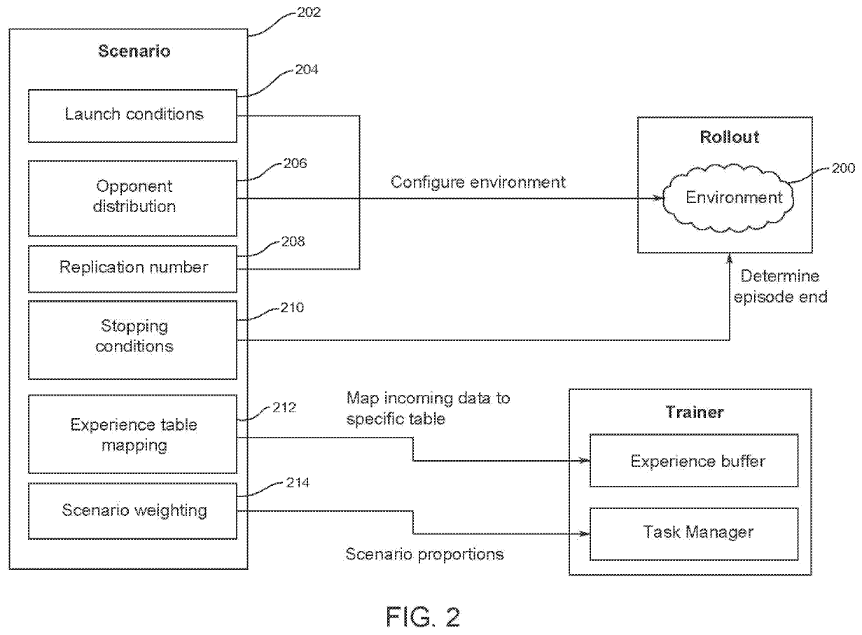

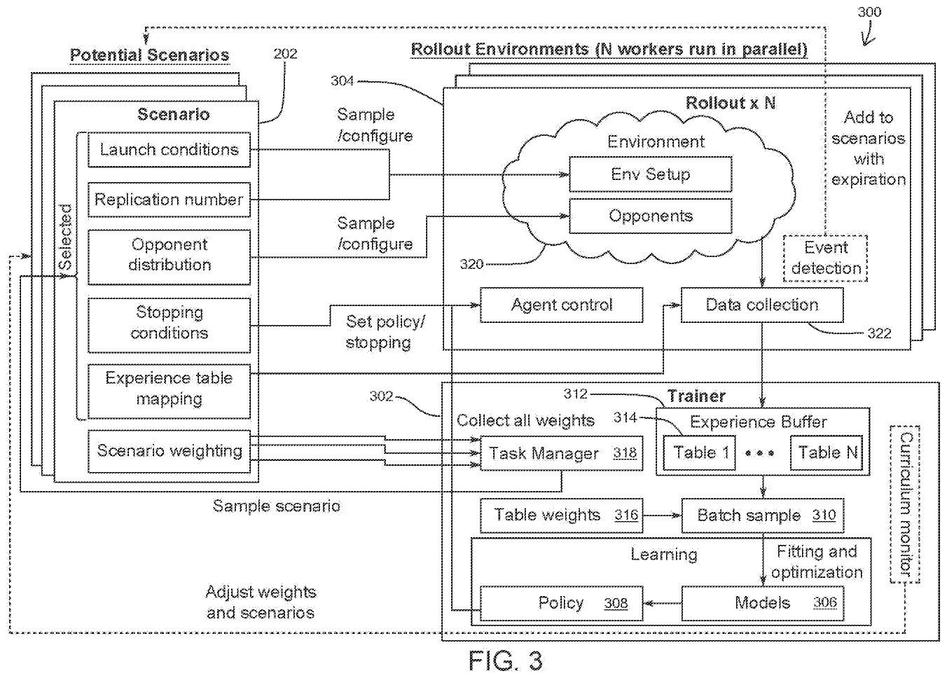

Embodiments of the present invention provide a technique called “mixed scenario training”, illustrated in FIGS. 2 and 3, as a solution to the problems discussed above. Mixed scenario training is designed for more complex domains, such as autonomous driving, but requires the ability (for instance via a simulator) to configure the environment 200 in order to launch a scenario. Instead of allowing the environment 200 to draw the initial state of the agent, important training situations are encoded in a scenario construct 202 made up of the information shown in FIG. 2.

Typically, the scenario construct 200 can include the following: (1) Launch conditions 204 specifying the beginning of a scenario. These conditions themselves may be randomized. For instance, in an autonomous driving task, a “1 on 1” scenario may stipulate a distribution over possible locations and speeds of a learning agent and one other car. (2) Opponent distribution 206 specifying the forms and probabilities of other agents in the scenario. For instance, in an autonomous driving scenario, potential opponents might include line followers, pre-built AI controllers, or even pre-trained RL policies. (3) A replication number 208 indicating the number of parallel agent scenarios to run in the environment. A scenario may be replicated many times in a particular environment. For instance, in an environment with capacity for 20 cars, 10 different one on one scenarios may be launchable as long as they are kept far enough apart. (4) Stopping conditions 210 for when this scenario will end, which may be time, distance, or condition based. (5) Scenario weighting 214 determining the proportion of this scenario in overall task sampling. For instance, a weighting of 0.1 on the “1 on 1” scenario could indicate that 10% of all tasks sampled should be from the 1v1 scenario. (6) Experience table mapping 212 can store data from particular scenarios in specific partitions called “tables” to ensure their representation in training batches and to prevent data imbalances with longer or shorter scenarios in the same training set.

An embodiment of the mixed scenario training process for a deep RL agent using parallel rollout workers is illustrated in FIG. 3. In this version, there are N possible workers, representing N potential environments where scenarios can be run in parallel. Data from those workers can be streamed back to an experience replay buffer on a centralized trainer which can perform computations to update the learning agent's policy and other models, as is standard in Deep Reinforcement Learning architectures. When workers complete rollout tasks, a new scenario can be drawn from the set of candidate scenarios and then its parameters, such as launch conditions and opponent types, can be further sampled. Multiple instances of the scenario (corresponding to the replication number) can be run in a single worker environment and data can be streamed back to the experience tables in the replay buffer specified by the scenario. Training can proceed periodically to update the policy with batches of data covering the various tables with pre-set proportions.

In some embodiments, the set of candidate scenarios can be dynamically extended based on events encountered during learning or policy evaluation. For instance, if two cars collide, the scenario right before the collision may be added to the set so that the agent can learn ways to avoid an imminent collision. This event detection feature is illustrated in a dashed box in FIG. 3.

In some embodiments, a curriculum may be used to adjust the proportions of scenarios based on some measure of progress. Examples of these progress measures include the number of training iterations or metrics measuring the performance of the current policy. For example, a curriculum in autonomous driving may start out only sampling scenarios where the learning agent is alone and later introduce “1 on 1” scenarios when the agent has displayed driving competency. This curriculum monitor feature is illustrated in a dashed box in FIG. 3

The mixed scenario training procedure addresses several issues of conventional methods, as described above. For example, the scenario launch conditions can free the agent from the burden of reaching or even planning to reach important scenarios. Also, by explicitly setting the launch configurations and sampling the opponent population, the need for “cooperative” opponents is alleviated. Further, the use of a scenario-to-table mapping and a re-weighting of data based on table proportions in each learning batch ensures important data from shorter or hard to reach situations will not be ignored in training. Finally, with their potentially rich encoding of launches, opponent behaviors, and stopping conditions, mixed scenario training can provide a vehicle for the encoding of prior knowledge by domain experts.

One embodiment of a deep reinforcement learning architecture 300 utilizing mixed scenario training is illustrated in FIG. 3. The two main modules in the architecture are a trainer 302 and a set of rollout workers 304. The trainer 302 can refine the models 306 and policy 308 used to determine actions in the environment. Various representations of these models 306 and policies 308 are possible, including deep neural networks. Policy refinement can be performed by sampling a “batch” of data 310 from an experience replay buffer 312 that has been populated with data from the various scenarios that have been run in the past. This replay buffer 312 may contain various tables 314 that partition the data, for instance, keeping the data from solo driving experience separate from data about driving in traffic. Whenever a batch is constructed for policy refinement, a pre-specified set of table weights 316 can be used to specify the proportion of data from each table used in the batch. Because the system links specific scenarios to tables (although not necessarily in a bijective relationship), this table sampling ensures a certain proportion of each scenario's data is used in the batch construction.

The trainer 302 also acts as a “task manager” 318, determining which scenarios should be started on an idle worker. Each time a worker indicates it has completed its previous scenario, the trainer 318 can perform a random draw from the set of potential scenarios based on the scenario weights. In other embodiments this randomization could be replaced by a circular queue or other deterministic sampling process. In either case, the selected scenario is then instantiated by performing random draws on its launch parameters (such as the placement of cars) and the population of opponents associated with this scenario. Again, these can be weighted random draws or a more complex history-based sampling to ensure balance of instantiated tasks.

The instantiated scenario can then be sent to the rollout worker 304 along with the current control policy. The rollout worker 304 can read this specification and instantiates the requested number of replicas (from the scenario parameters) of the scenario in the configurable environment 320. For instance, this process could involve setting up a driving simulator with several well-spaced “1 on 1” scenarios. The rollout worker 304 can then execute the scenario using the communicated policy to select actions for all learning agents on each step. Data is recorded 322 from the environment 320, specifically the state, actions, and rewards of all agents and sent to the table 314 in the experience replay buffer 312 specified by the scenario. This process continues until the ending condition of the scenario is reached. This ending condition can alternatively be time based (run the scenario for X seconds), distance based (drive an autonomous car for X miles) or be conditioned on other events (run for an hour or until you collide with something).

Various extensions of the architecture are possible, including these two variations described below. First, a variation is possible where the set of potential scenarios may be increased dynamically based on events encountered while running rollout tasks. In an example instantiation, an event such as a collision between vehicles may be specified. When such an event happens during rollout collection or a policy evaluation, the state from some time before the event occurrence (for instance ten seconds before the collision) may be transmitted back to the trainer and a new scenario can be dynamically constructed and added to the set of possible scenarios. This scenario would then aid in teaching the agent to avoid the undesirable event (a collision in this case). Such “replay” scenarios may also be specified with a limit on the number of times they will be executed, allowing them to expire in the set of potential scenarios and potentially make room for other replay scenarios.

Another potential variation occurs when using a curriculum to change the set of potential scenarios or their proportional weights. In this variation, a curriculum can be specified where the set of potential scenarios or their weights are updated based on the curriculum phase. A curriculum phase is triggered by a learning event which could be simply the number of policy updates that have been performed or more complex criteria involving metrics recorded by the rollout workers in various scenarios (such as the driving aptitude of a policy). For example, a curriculum in autonomous driving may start out only sampling scenarios where the learning agent is alone and later introduce “1 on 1” scenarios when the agent has displayed driving competency.

Several techniques in the reinforcement learning literature share terminology with mixed scenario training but have non-trivial gaps with the architecture, data structures, and procedures described above. For example, targeted exploration algorithms can seek out specific states where an agent feels it needs more experience. However, these algorithms fall short in complex domains as they have no ways of handling the problems discussed above. In particular, triggered exploration algorithms cannot control or even sample opponent behavior, meaning they may never be able to reach the states they want to explore. By contrast, mixed scenario training, according to aspects of the present invention, can directly configure the environment in an appropriate launch condition and sets or samples the opponent policies as desired.

Curriculum learning in reinforcement learning sometimes contains modules that “generate” new environments, which can be seen as a form of scenario generation. However, this generation is used to replace prior environments that the agent has mastered in a sequential fashion. By contrast, mixed scenario training, according to aspects of the present invention, can deal with the problem of balancing many different scenarios at once in complex domains where multiple source tasks are needed to maintain different skills.

While there are many RL applications that are trained on multiple environments to promote generalization, the goal of such agents is to be able to perform in many different small environments. By contrast, mixed scenario training, according to aspects of the present invention, can focus on a domain that is an extremely large, monolithic environment, such as autonomous driving, but where training in specific scenarios will build skills that promote good behavior in the full complex scenario.

The reinforcement learning options framework encodes many different small policies for different areas in a large domain. However, this approach is fundamentally different from mixed scenario training, which, according to aspects of the present invention, can seek to learn a single generalized policy for the large domain with experience from targeted scenarios.

In summary, mixed scenario training for reinforcement learning agents can be used in complex domains, where scenarios each focused on specific skills can be sampled and partitioned in the training data in order to create policies that excel at all the desired behaviors. Scenarios can be designed with launch configurations that may themselves be randomized but allow the learning agent to “spawn” in situations that will be useful in learning a specific skill. Scenarios can be drawn from either set opponent types or a distribution. These opponents are typically well behaved in the scenarios (for instance line following vehicles), enabling learning and exploration of the scenario that would not be otherwise possible. Stopping conditions can be based on time, distance, or other criteria, allowing scenarios to be short and focused on specific skills or be long, potentially open ended, focusing on more general techniques. Mapping of each scenario to a “table” partition in the experience replay buffer can provide the learning agent with sufficient data from each scenario despite differences in their duration or sampling rates. Aspects of the present invention provide the ability to run many replicas of a scenario at once in a large environment, for instance, collecting data from many “solo” agents well-spaced out in a driving environment. Aspects of the present invention further provide the ability to run many different scenarios in parallel across many rollout workers, as managed by a task manager in the training module. Aspects of the present invention provide for event-triggered additions of new scenarios encountered during rollout activity to the set of potential scenarios. Finally, curriculum logic can be used to vary the distribution of sampled scenarios over time or based on performance metrics collected from rollouts or other policy evaluation.

Methods according to embodiments of the present invention can solve, for the first time, the simulated racing challenge using model-free deep reinforcement learning. Aspects of the present invention provide a novel reinforcement learning algorithm and enhance the learning process with mixed scenario training to encourage the agent to incorporate racing tactics into an integrated control policy. In addition, methods of the present invention have constructed a reward function that enables the agent to adhere to the sport's racing etiquette rules. Specific examples discussed below demonstrate the capabilities of an artificial agent by winning three out of three against four of the world's best racing game drivers. This demonstrates that the agent training methods according to aspects of the present invention can be successfully used to train championship-level automated race car drivers, where such methods can be further applied in other complex dynamical systems and real-world applications.

A game agent can be trained using a deep reinforcement learning algorithm, including but not limited to quantile-regression soft actor-critic (QR-SAC). This approach learns a policy (actor) that selects an action based on the agent's observations, and a value function (critic) that estimates the future rewards of each possible action. QR-SAC extends the soft actor-critic approach by replacing the expected value of future rewards with a representation of the probability distributions of those rewards and modified to handle N-step returns. Both the actor and critic can be represented by neural networks with four layers of 2048 nodes each. QR-SAC can train the neural networks asynchronously; it samples data from an experience replay buffer (ERB), while actors simultaneously practice driving using the most recent policy and continuously fill the buffer with their new experiences.

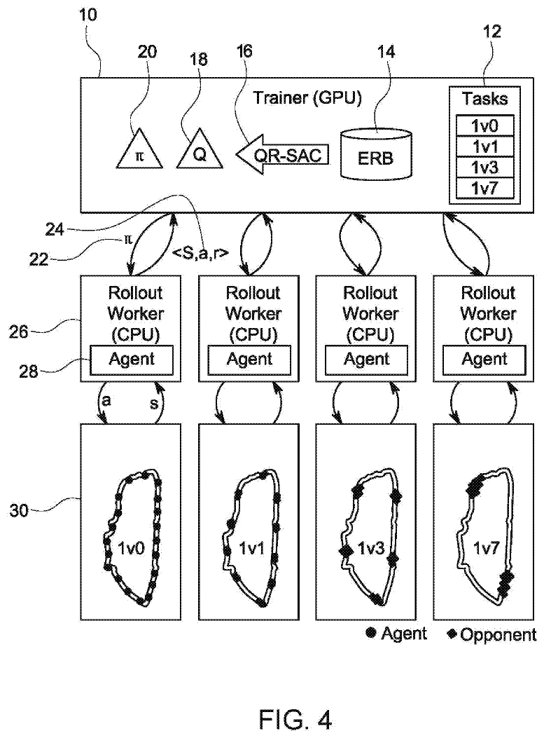

The system is illustrated in FIG. 4. The trainer 10 distributes training scenarios to rollout workers 26, each of which controls one game console running an instance of the game. An agent 28 within the rollout worker 26 runs one copy of the most recent policy 22, 7C, to control up to 20 cars on a track 30. The agent 28 sends an action, a, for each car it controls to the game. Asynchronously, the game computes next frames and sends each new state, s, to the agent 28. When the game reports the action has been registered, the agent 28 reports the state, action, reward tuple 24<s, a, r> to the trainer 10 which stores it in the ERB 14. The trainer 10 samples the ERB 14 to update the policy 20, 7C, and Q-function 18 networks via the QR-SAC 16. FIG. 4 illustrates a system with four rollout workers 26 currently tasked with running 1v0, 1v1, 1v3, and 1v7 scenarios 12.

The agent's core actions can be mapped to two continuous-valued dimensions: changing velocity (accelerating or braking), and steering (left or right). The effect of the actions can be enforced by the game to be consistent with the physics of the environment. For example, the agent can be prevented from braking harder than humans, but the agent can learn more precisely when to brake. The agent can interact with the game at 10 Hz, which is within the range that professional players interact with video games.

The agent can have access to the positions, velocities, accelerations, and other relevant state information about itself and all opponents. The agent can also have a map of the track as a list of points defining the left and right edges and the center line. The agent may not have other information available in the visual image, like the size and shape of kerbs or the type of surface outside the track edge.

### Racing Tactics

To learn racing tactics with deep reinforcement learning (RL), the agent needs to represent its observations of other cars in a way that can be interpreted by a neural network. The agent can maintain two lists of the state features of the opponents: one for cars in front of the agent and one for cars behind the agent. Both lists can be ordered from closest to farthest and limited by a maximum range.

In some embodiments, the progress reward alone may not be enough to incentivize the agent to win the race. If the opponent was sufficiently fast, the agent would learn to follow it and accumulate large rewards without risking potentially catastrophic collisions. Adding rewards specifically for passing can help the agent learn to overtake other cars. A passing reward can be used that is proportional to the distance by which the agent improved its position relative to each opponent within the local region. The reward can be symmetric, so if an opponent gained ground on the agent, the agent would see a proportional negative reward.

Another complication presented when learning tactics is that behavior can be greatly influenced by ones opponents. Overly combative or overly submissive opponents may lead an agent to learn degenerate passing behavior or make aggressive maneuvers. To avoid such instabilities, rather than practicing against a copy of itself, the agent can practice against curated policies from prior experiments that were selected for not exhibiting unsportsmanlike behaviors. Mixed scenario training supports the use of such populations through the opponent distribution construct, allowing each scenario to potentially have its own unique mix of opponent types and a distribution over their usage in these training scenarios.

Finally, the opportunities for the agent to learn certain skills can be rare. This can be referred to as an exposure problem, where certain states of the world are not accessible to the agent without the cooperation of its opponents. For example, to execute a “slingshot pass”, a car must be in the slipstream of an opponent on a long straightaway, a condition which may occur naturally a few times or not at all in an entire race. If that opponent always drives only on the right, the agent may learn to pass only on the left and would be easily foiled by a human who chose to drive on the left. Mixed scenario training addresses this issue. A small number of race situations that were likely to prove pivotal on each track can be identified. Then, scenarios can be configured that present the agent with noisy variations of those critical situations. In some scenarios, simple PID controllers can be used to ensure that the opponents followed certain trajectories, such as driving on the left, for which it was desirable that the agent be prepared to encounter. This technique resulted in more robust skills being learned by the agent.

### Training Scenarios

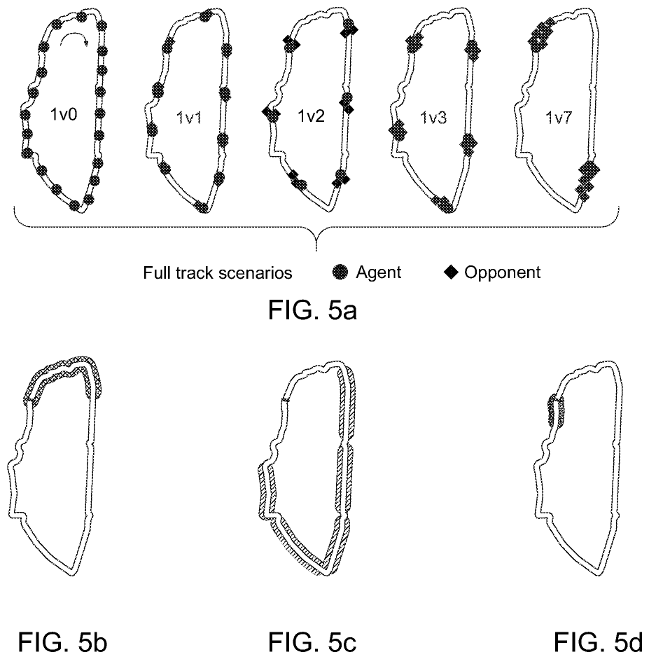

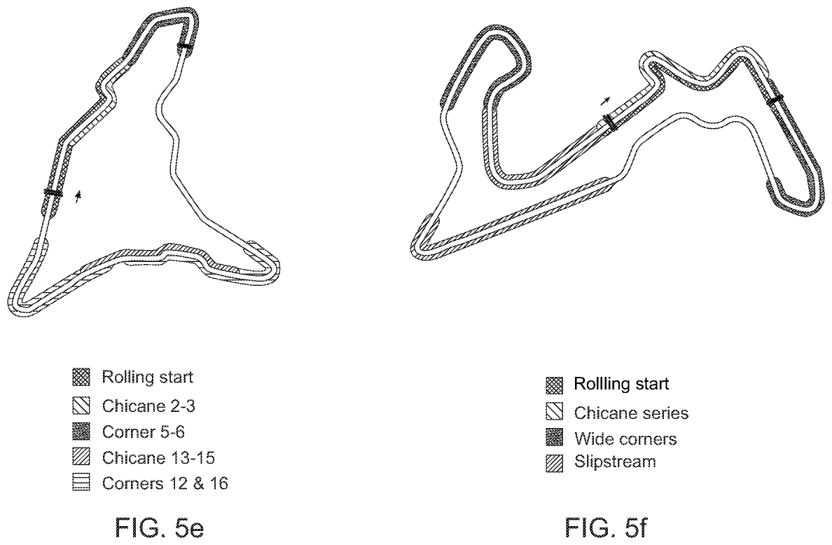

Learning to race requires mastering a gamut of skills: surviving a crowded start, making tactical open-road passes, and precisely running the track alone. To encourage basic racing skills, the agent was placed in scenarios with zero, one, three, or seven opponents launched nearby (1v0, 1v1, 1v2, 1v3, and 1v7, respectively). To create variety, track positions, start speeds, spacing between cars, and opponent policies can be randomized. The fact that the game supports 20 cars at a time can be leveraged to maximize game console utilization by launching more than one group on the track. All base scenarios ran for 150 seconds. In addition, to ensure the agent was exposed to situations that would allow it to learn the skills highlighted by expert advisors, time- or distance-limited scenarios can be utilized on specific course sections. Exemplary skills scenarios can include 8-car grid starts, 1v1 slipstream passing, driving through tight chicanes in a crowd in each of the possible traffic positions, practicing passing opportunities in specific turn sequences that provide multiple racing lines and overtaking opportunities, practicing defensive maneuvers in the same corners while racing in front, and combinations of the offensive and defensive driving when in between other cars. Illustrations of these scenarios on three racing tracks are shown in FIGS. 5a through 5f. To learn how to avoid catastrophic outcomes at a particularly high-speed track, replay tasks from the extensions described earlier can be incorporated.

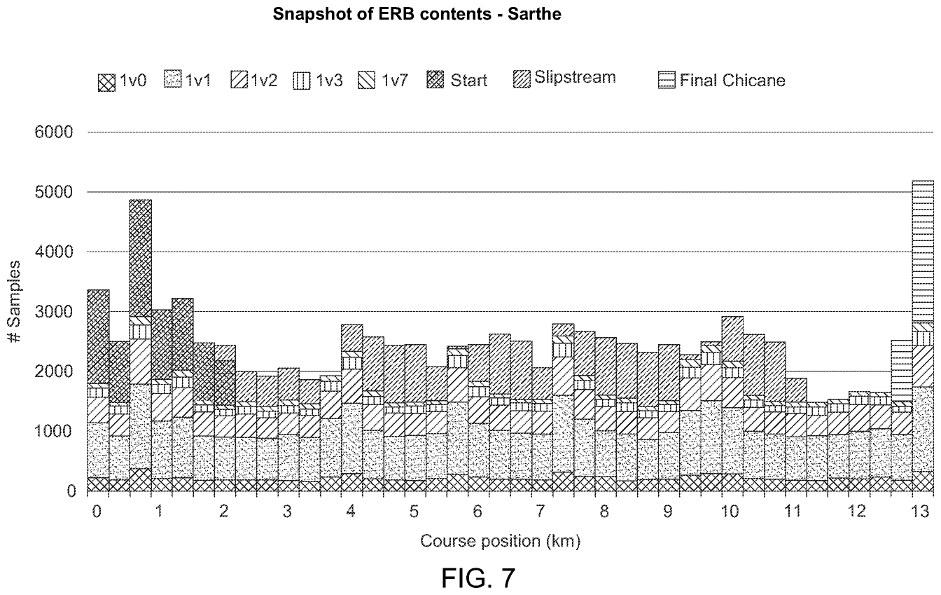

Unlike curriculum training, where early skills are supplanted by later ones, or in which skills build on top of one another in a hierarchical fashion, the training scenarios used in aspects of the present invention are complementary and were trained into a single control policy for racing in traffic. During training, the trainer assigned new scenarios to each rollout worker by selecting from the set configured for that track based on hand-tuned ratios designed to provide sufficient skill coverage. However, even with this relative execution balance, random sampling fluctuations from the buffer can lead to skills being forgotten between successive training epochs. Therefore, multi-table stratified sampling based on the table sampling weights described earlier can be implemented that explicitly enforces proportions of each scenario in each training mini-batch, significantly stabilizing skill retention. An example experience replay buffer with data partitioned into multiple tables is shown in FIG. 7.

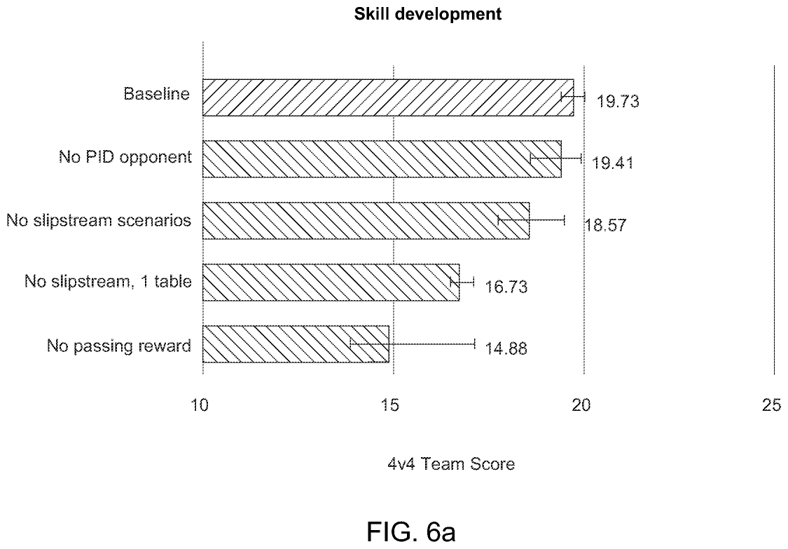

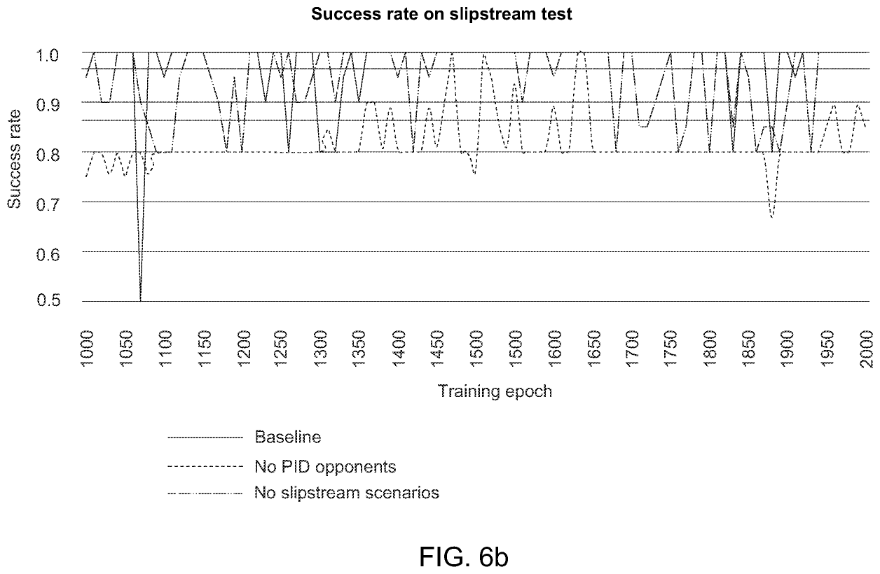

The importance of various aspects of mixed scenario training is shown in FIGS. 6a and 6b which presents ablation studies of several components. The results, showing scores of each agent against a common opponent in 4v4 races, indicate the importance of controlling the population of a scenario (“no PID opponents”), using specific scenarios to train skills (“no slipstream”), and the suage of multiple tables to organize skill-specific data in the experience replay buffer. The line chart shows various agents' ability to pass another agent in a “slipstream” evaluation scenario. The solid lines represent the performance of one seed in each condition and the dotted lines represent the means of all seeds over all epochs. While the baseline skills sometimes fluctuate, the effect is more common in the other conditions.

### Experimental

### Game Environment

Since its debut in 1997, the Gran Turismo® (GT) franchise has sold over 80 million units. The most recent release, GT Sport, is known for precise vehicle dynamics simulation and racing realism, earning it the distinction of being sanctioned by FIA and selected as a platform for the first Virtual Olympics. GT runs only on Play Station® 4's, and at a 60 Hz dynamics simulation cycle. A maximum of 20 cars can be in any race.

The agent runs asynchronously on a separate computer and communicates with the game via HTTP over wired Ethernet.

The agent requests the latest observation at 60 Hz but makes decisions and emits an action every 100 ms (10 Hz). Action frequencies from 5 Hz to 60 Hz were tested and there was found no significant performance gains from acting more frequently than 10 Hz. The agent must be robust to the infrequent, but real, networking delays. The agent's action is treated the same as a human's game controller input, but only a subset of action capabilities are currently supported in the GT API. For example, the API does not allow the agent to control gear shifting, the Traction Control System, or the brake balance, all of which can be adjusted in the game by the players.

### Computing Environment

Each experiment used a single trainer on a compute node with either one NVIDIA V100 or half of an NVIDIA A100 coupled with approximately 8 vCPUs and 55 GiB of memory. Some of these trainers were run in data centers and some were run in AWS EC2 using p3.2×large instances.

Each experiment also used a number of rollout workers, where each rollout worker consisted of a game console and a compute node (see FIG. 4). In this setup, the game console ran the game, and the compute node managed the rollouts by doing tasks such as computing actions, sending them to the game, sending experience streams to the trainer, and getting updated policies from the trainer (see FIG. 4). The compute node used approximately 2 vCPUs and 3.3 GB of memory. Typically, one worker was primarily evaluating intermediate policies rather than generating new training data. To train racing policies, 21 rollout workers were used for approximately 14 days.

### Actions

The GT API allows for the control of three independent continuous actions: throttle, brake, and steering. Because the throttle and brake are rarely engaged at the same time in practice, the agent was presented control over the throttle and brake as one continuous action dimension. Both throttle/brake and steering were scaled to a range of [−1, 1]. The policy network selects actions by outputting a squashed normal distribution with a learned mean and diagonal covariance matrix over these two dimensions.

### Features

The state features input to the neural networks are either directly available from the game state or processed into more convenient forms and concatenated before being input to the models for training. Features include but are not limited to the following. A set of “time trial features captured the car's 3D velocity, 3D angular velocity, 3D g-force, load on each tire, and the tire slip angles, sine and cosine components, the local course surface inclination, the car's orientation with respect to the course center line, and a set of course points outlining upcoming sections of track. The agent also received indicators if it contacted a fixed barrier, was considered off-course by the game, and received real-valued values for the game's view of the car's most recent steering angle, throttle intensity, and brake intensity.

When training the agent to race against other cars, the list of features also included a car contact flag to detect collisions and a slipstream scalar that indicates if the car was experiencing the slipstream effect from the cars in front of it. To represent the nearby cars, the agent used a fixed forward and rear distance bound to determine which cars to encode. The cars were ordered by their relative distance to the agent and represented using their relative position, velocity and g-force.

To keep the features described here in a reasonable numerical range when training neural networks, the inputs can be standardized based on the knowledge of the range of each feature scalar. It can be assumed that the samples were drawn from a uniform distribution given the range and computed the expected mean and standard deviation. These were used to compute the z-score for each scalar before being input to the models.

### Rewards

The reward function used to train the agent was a hand-tuned linear combination of multiple individual components. Components included a reward for progress according to the agent's movement along the course centerline, penalties for going off course, hitting a wall, or wheel slippage, a bonus for passing other cars, and various penalties for hitting other cars, with larger penalties provided for particularly egregious collisions clearly caused by the agent such as hitting another car from behind. On certain tracks and cars, these components were weighted differently, and some were even removed, to ensure the agent could utilize the track and cars to their physical limits as long as they stayed within the bounds of racing etiquette.

### Results

To evaluate the agent, the agent was raced in two events against top human drivers. In the first event three of the world's top drivers were asked to try to beat the agent's lap times on the three tracks. The human drivers were allowed to see a “ghost” of the agent as they tried to beat its lap time. In these races, the agent won all three matches. Notably, there is evidence that at least one driver, learned from, or was inspired by, the agent, and has improved his own time trial performance since the event. This human driver has the best human time in FIG. 7 (as indicated by the circled number one).

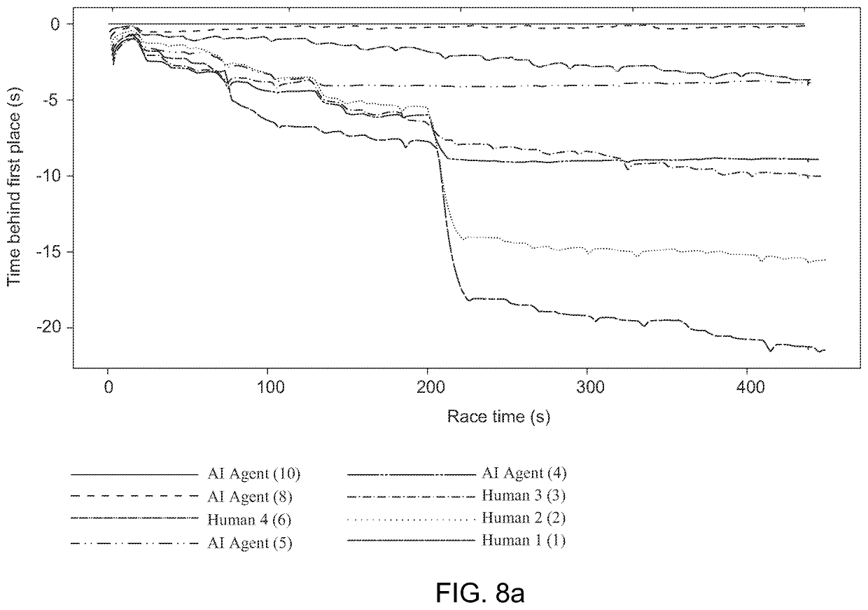

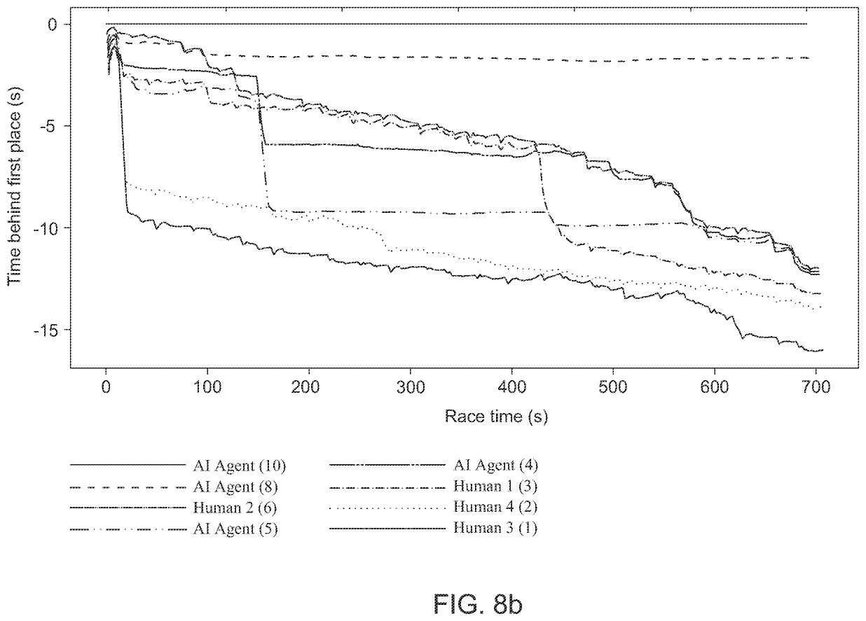

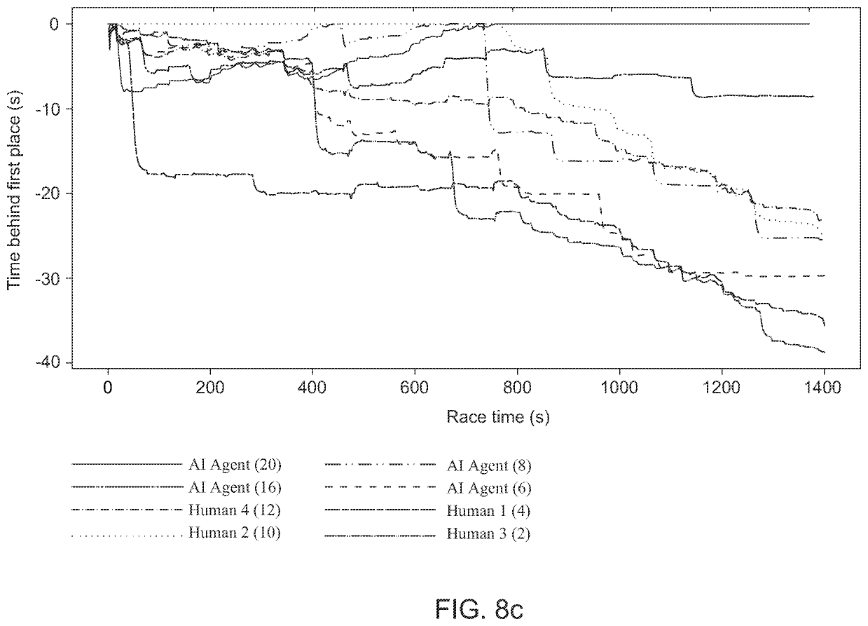

A second event included some of the world's best game drivers. The event consisted of one race on each track. Four top game drivers formed a team to compete against four instances of the agent. Points were awarded, as shown in parathesis in FIGS. 8a through 8c for each driver, to the team based on the final positions (10 points for first, 8 points for second, 6 points for third, and 5, 4, 3, 2, 1 for the remaining positions) with the longest and most challenging race counting double. Because the agent had the best times in the pre-race seeding laps, the agents started in the odd positions in all three races. The humans started in the even positions and chose their order within the team.

The agent placed first in all three of the races and had the fastest lap times in all three. The agent took first place in all three races and finished in places 1, 2, 4, 5 in both of the first two races and finished in places 1, 2, 5, 6 in the third, most complicated, race. FIGS. 8a through 8c illustrate the placement of the agent and human cars throughout each race. These results gave the agent an overall score of 104-52 over the humans. The results clearly show that the agent outraced the best human drivers in the world. The agent combined impressive speed with real racing skills, successfully passing top drivers on straights and in curves.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

1. A method of training a reinforcement learning agent with mixed scenario training comprising:
providing a rollout worker in an environment having one or more predetermined scenario properties;
operating the rollout worker in the environment while focusing on one or more specific skills;
providing a reward for successfully achieving the one or more specific skills; and
creating a policy for the rollout worker to optimize the reward.

2. The method of claim 1, further comprising streaming data from the rollout worker to an experience reply buffer, wherein the data in the experience reply buffer is partitioned into one or more tables.

3. The method of claim 2, further comprising re-weighting data in the experience reply buffer based on table proportions to ensure data from hard to reach situations is not ignored.

4. The method of claim 1, wherein the scenario properties include one or more of launch conditions, opponent distribution options, a replication number, stopping conditions, experience table mapping and scenario weighting.

5. The method of claim 1, further comprising launching an additional rollout worker in an additional environment having a predetermined set of scenario properties.

6. The method of claim 5, wherein the predetermined set of scenario properties is randomly selected.

7. The method of claim 5, wherein the predetermined set of scenario properties is selected based on a scenario weighting.

8. The method of claim 5, wherein the predetermined set of scenario properties is automatically created from an event encountered from a prior rollout worker in a prior environment.

9. The method of claim 1, further comprising providing a scenario properties of an opponent distribution that is well-behaved in the environment.

10. The method of claim 1, wherein the scenario properties include a replication number defining a number of parallel rollout workers to operate in the environment.

11. The method of claim 1, wherein the scenario properties include a stopping condition.

12. The method of claim 11, wherein the stopping condition is determined to generate an environment focused on a specific skill achievement.

13. The method of claim 11, wherein the stopping condition is open-ended, focusing the rollout worker on achieving general techniques.

14. A deep reinforcement learning architecture using mixed scenario training comprising:
a set of rollout workers;
a trainer; and
a set of scenario properties, wherein
the trainer refines models and policies used to determine actions of a rollout worker in an environment;
the rollout workers operate in the environment based on predetermined launch conditions retrieved from the scenario properties; and
data from the rollout workers operating in the environment with the predetermined launch conditions is collected and stored in an experience replay buffer of the trainer.

15. The deep reinforcement learning architecture of claim 14, wherein the trainer performs a policy refinement by sampling a batch of data from the experience replay buffer that has been populated with data from operation of the set of rollout workers in the environment with various launch conditions.

16. The deep reinforcement learning architecture of claim 15, wherein the experience replay buffer includes tables for partitioning the data.

17. The deep reinforcement learning architecture of claim 16, wherein the batch of data includes data from multiple ones of the tables, wherein each table is provided a predetermined table weight.

18. The deep reinforcement learning architecture of claim 14, wherein the trainer includes a task manager module for determine which scenario properties should be used by an idle one of the set of rollout workers.

19. The deep reinforcement learning architecture of claim 14, wherein the data in the experience replay buffer includes a state, an action and rewards of each of the rollout workers.

20. A method of training an agent with deep reinforcement learning to interact in a racing video game, comprising:
learning a policy that selects an action based on observations by the agent and based on a value function that estimates a future rewards for each possible action;
mapping core actions of the agent to either a changing velocity dimension and a steering dimension, wherein the changing velocity dimension and the steering dimension are both continuous-valued dimensions; and
training the agent in an environment with predefined scenario properties, wherein
the predefined scenario properties includes launch conditions, opponent distribution options, a replication number, stopping conditions, experience table mapping and scenario weighting.
